(19) United States
(12) Patent Application Publication
(10) Pub. No.: US 2008/0094216 A1
(43) Pub. Date: Apr. 24, 2008

(54) Material for wrapping a container and obtaining digital signature of the wrapped object

(76) Inventor: Fernando Atila Catania, San Martin (AR)

Correspondence Address: ARENT FOX LLP, 1050 CONNECTICUT AVENUE, N.W., SUITE 400, WASHINGTON, DC, 20036, US

(21) Appl. No.: 11/585,339

(22) Filed: Oct. 24, 2006

(51) Int. Cl. G08B 13/14

(52) U.S. Cl. 340/572.1

(57) ABSTRACT

This invention relates to a product that can be used for wrapping any holding body (ie; box, luggage, container, loading truck, trailer, etc.) that must be secured and confirmed unopened, violated or modified between its place of origin and its destination. The material for wrapping the container includes a random distribution of stiff and/or flexible RFID or Rubee or Smart dot tags or equivalent tags on a flat wrapping material which may be polyethylene, plastic or any other material capable of containing such tags and being suitable for coating or wrapping a holding body. Any other similar tag devices being developed at the present time may also be used under specific application conditions as the case may be.

This invention relates to a product that can be used for wrapping any holding body (ie; box, luggage, container, loading truck, trailer, etc.) that must be secured and confirmed unopened, violated or modified between its place of origin and its destination. The material for wrapping the container includes a random distribution of stiff and/or flexible RFID or Rubee or Smart dot tags or equivalent tags on a flat wrapping material which may be polyethylene, plastic or any other material capable of containing such tags and being suitable for coating or wrapping a holding body. Any other similar tag devices being developed at the present time may also be used under specific application conditions as the case may be.

### BACKGROUND OF THE INVENTION

A RFID tag is a small device, such as a sticker, that can be attached or placed on a product, animal or person. RFID tags have antennas to enable the RFID to receive and respond radio frequency requests from a RFID transmitter-receiver. Passive tags do not require inner electric supply while active tags do require it.

Passive RFID tags do not have an own supply source. The minimum electric current induced in the antenna by the radio frequency scanning signal supplies enough power to the tag integrated CMOS circuit to enable it to transmit a response. For energy and cost concerns, the passive RFID tag response is short, usually slightly one identification number (GUID).

It is the lack of an own supply source that makes it possible that the device may be quite small. In practice, passive tags have reading distances varying from 10 millimeters to 6 meters according to the antenna size of the tag and the power and frequency in which the reader operates. In 2005, the smallest commercially available device of this kind had a size of 0.4 millimeters×0.4 millimeters and it was thinner than a paper sheet. Said devices are almost invisible.

If a RFID device were wrapped with a Faraday armor, said device would have very attenuated incoming and leaving signals even to an extent they could not be used. A very simple Faraday armor would be a wrapping of an aluminium or lead foil. A more effective one would be a copper rectangle around the object although the aluminium foil would serve for most of the purposes. An implanted RFID would be more difficult to neutralize with said armor, but also a simple cover of aluminium foil would attenuate the component of signal electrical field.

The permanent neutralization of the RFID might need a strong alternating electric current adjacent to the RFID that overloads the tag and destroys its electronics.

In some cases, according to the RFID composition, a strong magnet may be serve to mechanically destroy the coil or the chip connection by means of the mechanical force exerted on the coil. With the development of the RFID technology, other methods may be necessary.

Tags of 125 kHz y 134 kHz are joined by a magnetic field rather than an electrical field. In view of the fact that the Faraday cage armors only the electrical component of the electromagnetic field, the armor of aluminium foil is uneffective. Any magnetic armor, such as a thin iron or steel foil, that encapsules the antenna coil of the tag will be effective.

### PREFERRED EMBODIMENT OF THE INVENTION

The produce proposed as an invention consists in a resistant plastic material sheet that includes a random distribution of RFID tags with a density in function of the size of the product to be wrapped and the desired security degree. For example, a 20 meter container of the type used in shipment is wrapped with more than one lining of material in order to achieve a single random superimposition for said container that depends not only on the distribution of the tags on the material but also on the initial position selected for the wrapping and the amount of linings. Additionally, some of the RFID may be transitorily or definitively neutralized throughout or before the wrapping process either willingly by destructing the tags with a strong magnet or by the inclusion of iron or steel foil or aluminium foils randomly in the wrapping material. Finally, once the wrapping process is finished, a unique and unforeseeable configuration of RFID tags is obtained and scanned. In this way, a single code of the distribution of the tags—which we may define as the “digital signature” of the object—which is identifiable with said container is also obtained. Any attempt to partially violate, destroy or cut said wrapping will sensitively modify the space distribution of the tags resulting in a different reading of the tag distribution on the container. Moreover, with a significant amount of tags, it is practically impossible to restore said distribution even when the result of the initial reading is known.

The use of passive RFID tags is very economical; however it does not exclude the use of other types of tags that may be combined with them to add a greater difficulty in foreseeing the scanning result. Likewise, an embedding may be used in the material as well as other things capable of neutralizing RFID tags by superimposition, such as aluminium foils, iron sheets or any other materials capable of housing and/or neutralizing the ID tags (RFID, Rubees, etc).

Whatever we are describing for RFID tags, is applicable too to Rubee tags or to any object mainly flat that can be attached to or incorporated into wrapping material for the purpose of identification using radio and/or magnetic waves.

Several uses apart from detecting violations to a container are available. Since we can obtain a “digital signature” of the object, we can identify the same at any place or case where we may have an available scanner. So we may locate containers shipped or at deposits or on transit, on trucks; we may automatically load and unload cargo. We may identify owners and destiny or origin of luggage at an airport or bus terminal. This product and method provides a “on site” and “unknown” and unique code, resulting in a optimal solution to ensure simultaneously certainty of lack of violation, plus means to electronically locate and drive the object wrapped by the present invention.

1- Material for wrapping a container characterized in that includes a random distribution of tags and being suitable for coating a holding body.

2- The material of claim 1, characterized in that tags are stiff

3- The material of claim 1, characterized in that tags are flexible

4- The material of claim 1, characterized in that the wrapping material includes both stiff and flexible tags

5- The material of claim 4, characterized in that the wrapping material is polyethylene.

6- The material of claim 1, characterized in that the wrapping material includes other material for neutralizing tags

7- The material of claim 6, characterized in that the material for neutralizing tags is aluminium foils or iron or steel sheets.

8- A method to wrap and monitor a container characterized by the following steps:
a—wrapping a body with the product of claim 1 with one lining of wrapping material in order to achieve a single random distrubition of tags for such particular body,
b—Scan the initial unique and unforeseeable configuration of tags a first time
c—Scan the known and determined configuration of tags anytime after the first time
d—Compare initial and any posterior scans result.

9- A method to wrap and monitor a container characterized by the following steps:
a—wrapping a body with the product of claim 1 with at least two lining of wrapping material in order to achieve a single random superimposition for such particular body,
b—Scan the initial unique and unforeseeable configuration of tags the first time
c—Scan the known and determined configuration of tags anytime after the first time
d—Compare initial and posterior scans result.

10- A method to wrap and monitor a container of claim 8 or 9, characterized by the following step to be executed after step a and before step b:
Destroying some tags.
